(19) United States
(12) Patent Application Publication
(10) Pub. No.: US 2025/0249392 A1
(43) Pub. Date: Aug. 7, 2025

(54) CARBON DIOXIDE RECOVERY DEVICE

(71) Applicant: HONDA MOTOR CO., LTD., Tokyo (JP)

(72) Inventors: Masayuki SADAKIYO, Saitama (JP); Hiroka SHIGI, Saitama (JP); Toshiyuki INABA, Saitama (JP); Masanobu TAKAZAWA, Saitama (JP)

(21) Appl. No.: 19/033,490

(22) Filed: Jan. 22, 2025

(30) Foreign Application Priority Data
Feb. 2, 2024 (JP) 2024-014552

(51) Int. Cl. B01D 53/04

(52) U.S. Cl. CPC B01D 53/0454; B01D 53/0438; B01D 53/0446; B01D 2257/504; B01D 2258/06; B01D 2259/40088

(57) ABSTRACT

A carbon dioxide recovery device includes: a first power supply that supplies electric power for cooling of sorbent material by a heat exchange device; a second power supply that supplies electric power to a valve; and a backup power supply that supplies electric power to the valve during power outage of the second power supply, in which, during power outage of the first power supply, the carbon dioxide recovery device executes, on the module, pressure maintenance control to maintain internal pressure of the module by controlling the valve using electric power of the second power supply to prevent influx of atmospheric air, and during power outage of the second power supply, controls the valve using electric power of the backup power supply to prevent influx of atmospheric air to the module, and to maintain the internal pressure of the module.

This application is based on and claims the benefit of priority from Japanese Patent Application No. 2024-014552, filed on 2 Feb. 2024, the content of which is incorporated herein by reference.

### BACKGROUND OF THE INVENTION

### Field of the Invention

The present invention relates to a carbon dioxide recovery device.

### Related Art

Among technologies for recovering a predetermined component from atmospheric air, exhaust gas and the like, technology for preventing damage to equipment during emergency has been known conventionally. As a document disclosing this type of technology, Japanese Unexamined Patent Application, Publication No. H8-168637 can be exemplified.

Japanese Unexamined Patent Application, Publication No. H8-168637 relates to an exhaust gas treatment system which introduces the exhaust gas discharged from a boiler or the like into a desulfurization absorption column via a chimney, and discharges the exhaust gas after desulfurizing in this desulfurization absorption column to outside. Japanese Unexamined Patent Application, Publication No. H8-168637 states that it is possible to prevent damage from the heat of exhaust gas, by introducing atmospheric air into the exhaust gas in the chimney by an air introduction means during an emergency to cause the exhaust gas temperature to drop.
Patent Document 1: Japanese Unexamined Patent Application, Publication No. H8-168637

### SUMMARY OF THE INVENTION

However, with a carbon dioxide recovery device, the recovery of carbon dioxide is performed by executing an adsorption process of aspirating a gas such as air containing carbon dioxide to a module retaining a sorbent material to adsorb this to the sorbent material, and a desorption process of reducing the pressure and heating the sorbent material to desorb the adsorbed carbon dioxide.

The sorbent material will oxidize if exposed to atmospheric air in a high-temperature state, and the adsorption performance will decline. Although valves are controlled so that the sorbent material is isolated from atmospheric air in the desorption process during normal operation, there is concern over a valve opening and the isolation of the sorbent material from atmospheric air being released during power outage or failure. Since it reaches a high-temperature state in the desorption process, if atmospheric air penetrates to the inside of the module, the sorbent material will deteriorate.

The present invention has an object of providing a carbon dioxide recovery device which can stop operation of a device or resume from stop, while maintaining a state which will not deteriorate the sorbent material.

According to a first aspect of the present invention, a carbon dioxide recovery device (for example, the carbon dioxide recovery device 1 described later) includes: a module (for example, the module 11 described later) that includes a sorbent material (for example, the sorbent material 12 described later) inside thereof, and executes an adsorption process of aspirating a gas containing carbon dioxide and adsorbing the carbon dioxide to the sorbent material; and a desorption process of desorbing the carbon dioxide from the sorbent material by heating in a state where a periphery of the sorbent material is reduced pressure; a heat exchanger (for example, the heat exchange device 80 described later) that performs cooling of the sorbent material by carrying out heat exchange with the module; a valve (for example, the first valve 21, second valve 22, third valve 23 and fourth valve 24 described later) for controlling influx and outflux of a gas relative to the inside of the module; a first power supply (for example, the first power supply 41 described later) that supplies electric power for performing cooling of the sorbent material by way of at least the heat exchanger; a second power supply (for example, the second power supply 42 described later) that supplies electric power to at least the valve; and a backup power supply (for example, the backup power supply 43 described later) that supplies electric power to the valve during power outage of the second power supply, in which during power outage of the first power supply, the carbon dioxide recovery device executes, on the module which was reduced in pressure and reached a high temperature in the desorption process, pressure maintenance control to maintain internal pressure of the module by controlling the valve using electric power of the second power supply to prevent influx of atmospheric air, and during power outage of the second power supply, controls the valve using electric power of the backup power supply to prevent influx of atmospheric air to the module which was reduced in pressure and reached a high temperature in the desorption process, and to maintain the internal pressure of the module.

According to a second aspect of the present invention, in the carbon dioxide recovery device as described in the first aspect, during power outage of the second power supply, the carbon dioxide recovery device may control the valve using electric power of the backup power supply 43 to prevent influx of atmospheric air and maintain internal pressure of the module, and control the heat exchanger using electric power of the first power supply to perform forced cooling of the module.

According to a third aspect of the present invention, in the carbon dioxide recovery device as described in the first or second aspect, during power outage of both the first power supply and the second power supply, the carbon dioxide recovery device may control the valve using the backup power supply to prevent influx of atmospheric air and maintain internal pressure of the module.

According to a fourth aspect of the present invention, the carbon dioxide recovery device as described in the third aspect may further include an inert gas tank (for example, the inert gas tank 69 described later) configured to supply an inert gas to the inside of the module, in which, during power outage of both the first power supply and the second power supply, the carbon dioxide recovery device may prevent influx of atmospheric air to inside of the module and supply the inert gas from the inert gas tank to the inside of the module.

According to the present invention, it is possible to provide a carbon dioxide recovery device which can stop operation of a device or resume from stop, while maintaining a state which will not deteriorate the sorbent material.

### BRIEF DESCRIPTION OF THE DRAWINGS

FIG. 1 is a schematic diagram showing a configuration related to a flow of a gas in a carbon dioxide recovery device according to an embodiment of the present invention;

FIG. 2 is a schematic diagram showing a configuration related to a flow of a liquid in the carbon dioxide recovery device according to the present embodiment;

FIG. 3 is a schematic diagram showing a configuration related to a flow of a gas in modules of the carbon dioxide recovery device according to the present embodiment;

FIG. 4 is a schematic diagram showing a configuration related to a flow of a liquid in a module of the carbon dioxide recovery device according to the present embodiment;

FIG. 5 is a schematic diagram showing a power supply system of the carbon dioxide recovery device according to the present embodiment;

FIG. 6 is a circuit diagram showing the relationship between a power supply system and a module of the carbon dioxide recovery device according to the present embodiment; and

FIG. 7 is a flowchart showing a flow of processing of operation control according to a power supply status of the carbon dioxide recovery device according to the present embodiment.

### DETAILED DESCRIPTION OF THE INVENTION

Hereinafter, embodiments of the present invention will be described by referencing the drawings.

### Overall Configuration

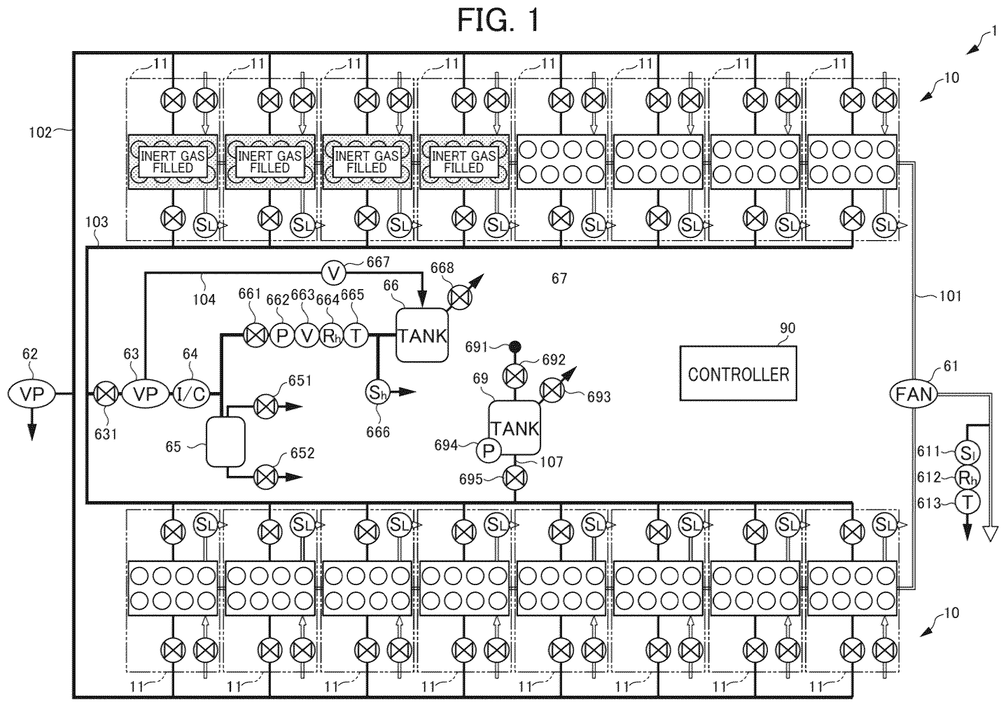

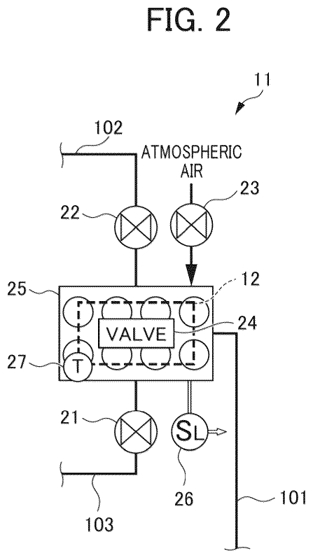

FIG. 1 is a schematic diagram showing a configuration related to a flow of a gas in a carbon dioxide recovery device 1 according to an embodiment of the present invention. FIG. 2 is a schematic diagram showing a configuration related to a flow of a liquid in the carbon dioxide recovery device 1 according to the present embodiment. It should be noted that illustration of configurations related the flow of liquid in the carbon dioxide recovery device 1 is omitted in FIG. 1, and the illustration of configurations related the flow of gas in the carbon dioxide recovery device 1 is omitted in FIG. 2.

The carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, and is reused as a fuel or raw material.

As shown in FIGS. 1 and 2, the carbon dioxide recovery device 1 of the present embodiment includes: a module unit 10, a fan 61, a vacuum pump 62, a carbon dioxide recovery pump 63, an intercooler 64, a separator 65, a carbon dioxide tank 66, a compressor 67, an inert gas tank 69, a heat exchange device 80, and a controller 90.

As shown in FIG. 1, the carbon dioxide recovery device 1 includes, as a gas flow path, an adsorption line 101, a vacuum line 102, a carbon dioxide line 103, a circulation line 104, and an inert gas supply line 107.

The module unit 10 is configured by a plurality of the modules 11 which adsorb carbon dioxide being arranged in a line. In the present embodiment, a total number of sixteen of the modules 11 are arranged by a pair of left and right module units 10.

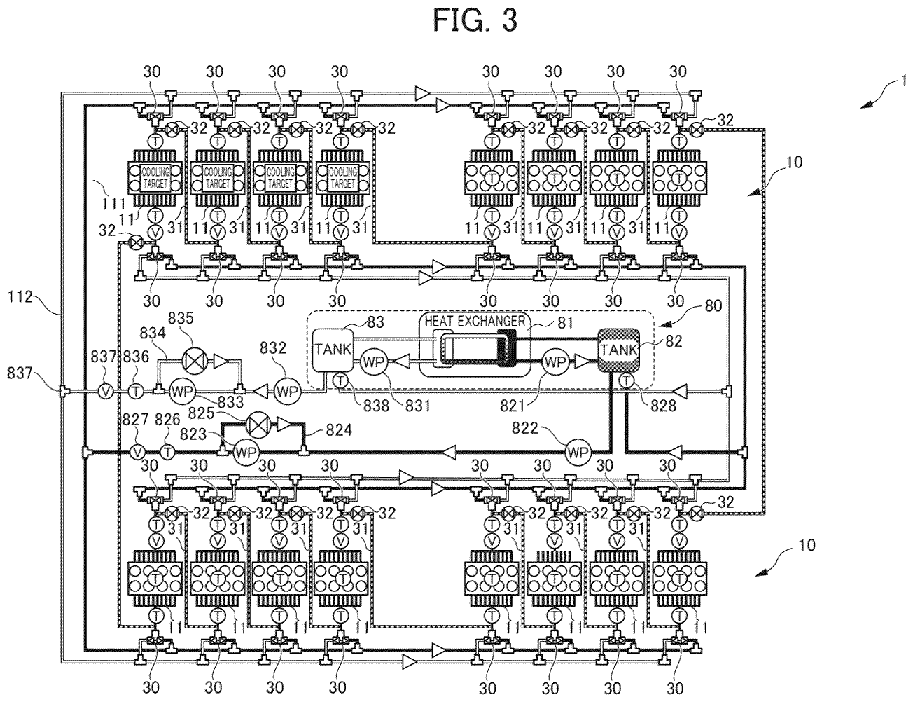

FIG. 3 is a schematic diagram showing a configuration related to a flow of gas in the modules 11 of the carbon dioxide recovery device 1 according to the present embodiment. The module 11 is a carbon dioxide recovery module that includes sorbent material 12, a first valve 21, a second valve 22, a third valve 23, a fourth valve 24, a pressure sensor 25, a carbon dioxide sensor 26, and a temperature sensor 27.

The sorbent material 12 is arranged inside of the module 11 in order to adsorb carbon dioxide. The sorbent material 12 is a member in particle form, and has a property of adsorbing carbon dioxide in a low-temperature state (for example, range of −30° C. to 50° C.), and desorbing (releasing) carbon dioxide in a state of high temperature (for example, range of 50° C. to 110° C.) and low concentration of carbon dioxide in the surroundings. As such a sorbent material 12, for example, a carbon dioxide sorbent material of a solid amine configured by supporting an amine on a porous material such as silica, or the like can be exemplified.

The first valve 21 is a switching valve arranged at a connection of the module 11 with a carbon dioxide line 103 recovering the carbon dioxide. A carbon dioxide recovery pump 63 is arranged in the carbon dioxide line 103. The second valve 22 is a switching valve arranged at a connection of the module 11 with the vacuum line 102 in which the vacuum pump 62 is arranged. The third valve 23 is a switching valve arranged at an inlet which suctions atmospheric air, etc. into the module 11. The fourth valve 24 is a switching valve arranged at a connection of the module 11 with an adsorption line 101.

The first valve 21, the second valve 22, the third valve 23 and the fourth valve 24 are all controlled to open and close by the controller 90. The first valve 21, the second valve 22, the third valve 23 and the fourth valve 24, for example, are configured by butterfly valves which are normal open.

The pressure sensor 25 measures the internal pressure of the module 11. The carbon dioxide sensor 26 measures the carbon dioxide concentration inside of the module 11. The temperature sensor 27 measures the temperature of the sorbent material 12. The measurement information of the pressure sensor 25, the carbon dioxide sensor 26 and the temperature sensor 27 is sent to the controller 90.

Referring back to FIG. 1, the adsorption line 101 and the fan 61 will be described. The adsorption line 101 is branched to connect to each of the respective modules 11. The fan 61 is arranged at portion of the adsorption line 101 at which branching portions merge. The fan 61 produces a flow of gas from “intake” to “exhaust” relative to the module 11 through the adsorption line 101 by being driven. The atmospheric air is thereby supplied into the module 11. A carbon dioxide concentration sensor 611, a moisture sensor 612 and a temperature sensor 613 are arranged in a portion of the adsorption line 101 exhausting the gas, and the carbon dioxide concentration exhausted from the adsorption line 101, moisture and temperature are measured. The measurement information of the carbon dioxide concentration sensor 611, the moisture sensor 612 and the temperature sensor 613 is sent to the controller 90.

The vacuum line 102 is branched to connect to each of the respective modules 11. The vacuum pump 62 is arranged at a portion of the vacuum line 102 at which the branched portions merge together. The vacuum pump 62 aspirates gas inside of the module 11 through the vacuum line 102 by way of being driven to make the inside of the module 11 a vacuum state or bring it close to a vacuum state.

The carbon dioxide line 103 is branched to connect to each of the respective modules 11. The carbon dioxide recovery pump 63, the intercooler 64, the separator 65, and the carbon dioxide tank 66 are arranged at a portion of the carbon dioxide line 103 at which the branching portions merge together.

The carbon dioxide recovery pump 63 applies a suction force to feed the carbon dioxide flowing through the carbon dioxide line 103 to the carbon dioxide tank 66. A one-way valve 631 is arranged on an upstream side of the carbon dioxide recovery pump 63 in the carbon dioxide line 103. A configuration is thereby made by which gas does not flow back from the intercooler 64 side to the module 11 side.

The intercooler 64 is an intermediate cooler which cools high-temperature gas containing carbon dioxide which was recovered from the module 11, and separates into gas and liquid.

The water produced by gas-liquid separation in the intercooler 64 is recovered in the separator 65. In addition, a first valve 651 and a second valve 652 are arranged at the separator 65, and the first valve 651 opens and closes the passage which communicates a gas-phase part of the separator 65 with atmospheric air. The second valve 652 opens and closes a path which communicates atmospheric air with a liquid-phase part of the separator 65.

The separator 65 separates carbon dioxide and water from the gas containing carbon dioxide having passed through the intercooler 64. In the separator 65, the separator first valve 651 and the separator second valve 652 are arranged. The separator first valve 651 opens and closes a path communicating with the gas phase part of the separator 65. The separator second valve 652 opens and closes a path communicating with the liquid phase part of the separator 65.

The carbon dioxide tank 66 stores the carbon dioxide recovered through the carbon dioxide line 103. A tank valve 661 is arranged on an upstream side of the carbon dioxide tank 66 in the carbon dioxide line 103. The tank valve 661 is controlled to open and close by the controller 90. In addition, between the tank valve 661 and the carbon dioxide tank 66 in the carbon dioxide line 103, various sensors such as a pressure sensor 662, a flowrate sensor 663, a moisture sensor 664, a temperature sensor 665 and a carbon dioxide concentration sensor 666 are arranged.

In addition to the carbon dioxide line 103, the circulation line 104 which returns ballast to the carbon dioxide recovery pump 63 is connected to the carbon dioxide tank 66. A flowrate sensor 667 is arranged in the circulation line 104. In addition, a pressure relief valve 668 which relieves pressure when becoming a pressure equal to or greater than a predetermined pressure, is arranged in the carbon dioxide tank 66.

Next, the inert gas tank 69 will be described. The inert gas tank 69 stores N₂ as an inert gas supplied from the N₂ gas bottle 691 at a fixed pressure or more (for example, 980 kPa). Between the inert gas tank 69 and the N₂ gas bottle 691, a gas bottle valve 692 is arranged. In addition, a pressure relief valve 693 which relieves pressure when the pressure becomes a predetermined pressure or more is arranged in the inert gas tank 69. A pressure sensor 694 is arranged inside of the inert gas tank 69. The pressure information measured by the pressure sensor 694 is sent to the controller 90.

The inert gas tank 69 is connected to the carbon dioxide line 103 via the inert gas supply line 107. An inert gas valve 695 is arranged in the inert gas supply line 107. The inert gas valve 695 is controlled to open and close by the controller 90.

The heat exchange device 80 will be described while referencing FIG. 2. The heat exchange device 80, upon each module 11 of the module unit 10 performing the desorption process, supplies thermal energy for heating inside this module 11 up to a predetermined temperature. In addition, the heat exchange device 80 recovers thermal energy which is unneeded upon each module 11 performing the adsorption process.

The heat exchange device 80 according to the present embodiment includes a heat exchanger 81, a cold water tank 82, a cold water line 111, a hot water tank 83, a hot water line 112, a three-way valve 30, a bypass path 31, and a bypass valve 32.

The heat exchanger 81 performs heat exchange between heat transfer medium flowing through the cold water line 111 and heat transfer medium flowing through the hot water line 112. The heat exchanger 81, for example, is a heat pump. The heat transfer medium, for example, is a liquid such as water. The heat transfer medium flowing in the cold water line 111 is cooled, and the heat transfer medium flowing in the hot water line 112 is heated by the heat transfer occurring in the heat exchanger 81.

The cold water tank 82 stores the heat transfer medium flowing in the cold water line 111. The heat transfer medium flowing in the cold water line 111 is stored in the cold water tank 82, and then is sent to the heat exchanger 81. In addition, the heat transfer medium cooled by the heat exchanger 81 is returned to the cold water tank 82, and then is sent to each module 11 through the cold water line 111. A heat-exchanger circulation water pump 821 is arranged between the cold water tank 82 and the heat exchanger 81 in the cold water line 111. By driving heat-exchanger circulation water pump 821, the heat transfer medium flowing in the cold water line 111 circulates between the cold water tank 82 and the heat exchanger 81.

The cold water line 111 is branched to connect to the upstream side and the downstream side of each of the respective modules 11, and connects the cold water tank 82 with each of the modules 11. In addition, a first cold-water circulation water pump 822 and a second cold-water circulation water pump 823 are arranged between the cold water tank 82 and each module 11 in the cold water line 111. In addition, a circulation line 824 which returns from the downstream side to the upstream side of the second cold-water circulation water pump 823 is arranged in the cold water line 111. A circulation valve 825 is arranged in this circulation line 824.

A temperature sensor 826 and a flowrate sensor 827 are arranged on the downstream side of the circulation valve 825 in the cold water line 111. In addition, a temperature sensor 828 is arranged in the vicinity of a portion of the cold water line 111 which returns the heat transfer medium to the cold water tank 82. The temperature sensor 828 measures the temperature of the heat transfer medium prior to circulating in the cold water line 111 to return to the cold water tank 82. The measurement information of the temperature sensor 826, the flowrate sensor 827 and the temperature sensor 828 is sent to the controller 90.

The hot water tank 83 stores the heat transfer medium flowing in the hot water line 112. The heat transfer medium flowing in the hot water line 112 is stored in the hot water tank 83, and then sent to the heat exchanger 81. In addition, the heat transfer medium heated by the heat exchanger 81 is returned to the hot water tank 83, and then sent to each module 11 through the hot water line 112. A heat-exchanger circulation water pump 831 is arranged between the hot water tank 83 and the heat exchanger 81 in the hot water line 112. By driving the heat-exchanger circulation water pump 831, the heat transfer medium flowing in the hot water line 112 circulates between the hot water tank 83 and the heat exchanger 81.

The hot water line 112 is branched to connect to the upstream side and the downstream side of each of the respective modules 11, and connects the hot water tank 83 and each module 11. In addition, a first hot-water circulation water pump 832 and a second hot-water circulation water pump 833 are arranged between the hot water tank 83 and each module 11 in the hot water line 112. In addition, a circulation line 834 which returns from the downstream side to the upstream side of the second hot-water circulation water pump 833 is arranged in the hot water line 112. A circulation valve 835 is arranged in this circulation line 834.

A temperature sensor 836 and a flowrate sensor 837 are arranged on the downstream side of the circulation valve 835 in the hot water line 112. In addition, a temperature 838 is arranged in the vicinity of a portion of the hot water line 112 which returns the heat transfer medium to the hot water tank 83. The temperature sensor 838 measures the temperature of the heat transfer medium prior to circulating in the hot water line 112 to return to the hot water tank 83. The measurement information of the temperature sensor 836, the flowrate sensor 837 and the temperature sensor 838 is sent to the controller 90.

The three-way valve 30 is connected to the cold water line 111, the hot water line 112 and the module 11. Three-way valves 30 are respectively arranged at the upstream side and the downstream side of the module 11. The three-way valve 30 is configured to be switchable between a cold-water connection state connecting the cold water line 111 and the module 11, a hot-water connection state connecting the hot water line 112 and the module 11, and a closed state blocking connection between the cold water line 111 and the hot water line 112 with the module 11.

The flow path switching of the three-way valve 30 is controlled by the controller 90. The heat transfer medium is introduced to the module 11 through the three-way valve 30 arranged on the upstream side, and the heat transfer medium is returned to the heat exchanger 81 side through the three-way valve 30 arranged on the downstream side.

The bypass path 31 is a flow path enabling the movement of the heat transfer medium between modules 11. The bypass path 31 connects between two modules 11. The modules 11 connected by the bypass path 31 may be adjacent modules, or may be modules 11 at non-adjacent separated positions.

The bypass valve 32 is arranged in the bypass path 31. A bypass valve 32 is arranged in each of a plurality of bypass paths 31. The bypass valve 32 is controlled to open and close by the controller 90.

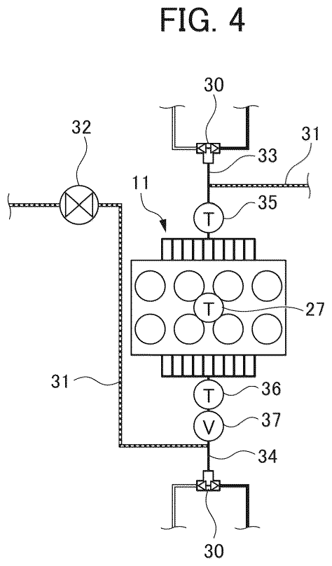

FIG. 4 is a schematic diagram showing a configuration related to a flow of liquid in the module 11 of the carbon dioxide recovery device 1 according to the present embodiment. As shown in FIG. 4, the module 11 includes: an inlet-side flow path 33 connected to an inlet to which the heat transfer medium flows, and an outlet-side flow path 34 connected to an outlet from which the heat transfer medium flows.

The bypass path 31 is connected to the outlet-side flow path 34 of the module 11, and is connected to the inlet-side flow path 33 of another module 11. In addition, a three-way valve 30 is arranged at an upstream-side end of the inlet-side flow path 33, and a three-way valve 30 is also arranged at a downstream-side end of the outlet-side flow path 34.

A temperature sensor 35 is arranged in the inlet-side flow path 33. A temperature sensor 36 and a flowrate sensor 37 are arranged in the outlet-side flow path 34. The measurement information of the temperature sensor 35, the temperature sensor 36 and the flowrate sensor 37 is sent to the controller 90.

Next, the controller 90 will be described. The controller 90 controls the operation of each part of the carbon dioxide recovery device 1. The controller 90 controls operations such as driving and stopping of devices used in the adsorption and desorption of carbon dioxide. The controller 90 performs switching control of the first valve 21, the second valve 22, the third valve 23 and the fourth valve 24 provided to each module 11, performs switching control of each bypass valve 32, and performs switching control of the separator first valve 651, the separator second valve 652, the tank valve 661 and the inert gas valve 695. In addition, the controller 90 performs driving control of the fan 61, the vacuum pump 62 and the carbon dioxide recovery pump 63, and switching control of the circulation valve 825 and the circulation valve 835. Furthermore, the controller 90 performs driving control of the heat-exchanger circulation water pump 821, the first cold-water circulation water pump 822, the second cold-water circulation water pump 823, the heat-exchanger circulation water pump 831, the first hot water circulation water pump 832, the second hot water circulation water pump 833, etc.

The controller 90, for example, is a computer that has a CPU (Central Processing Unit), ROM (Read Only Memory), RAM (Random Access Memory), etc. The controller 90 may be configured as one unit, or may be configured by several units.

### Recovery of Carbon Dioxide

Next, control for recovering carbon dioxide by the controller 90 will be described. The carbon dioxide recovery device 1 removes and recovers carbon dioxide from the air by alternately performing an adsorption process of adsorbing carbon dioxide in a gas aspirated such as atmospheric air to the sorbent material 12 in the module 11, and a desorption process of desorbing the carbon dioxide adsorbed to the sorbent material 12, and then storing the desorbed carbon dioxide in the carbon dioxide tank 66.

The adsorption process is a process of adsorbing carbon dioxide to the sorbent material 12 inside the module 11. In the adsorption process, the third valve 23 and the fourth valve 24 of the module 11 are opened, and the first valve 21 and the second valve 22 are closed. The fan 61 is driven, whereby a flow of gas from upstream to downstream is generated, and the gas containing carbon dioxide (for example, atmospheric air) is aspirated through the third valve 23. The aspirated gas passes through the sorbent material 12 inside the module 11. At this time, the inside of the module 11 is room temperature (25° C.), and the carbon dioxide in the gas is adsorbed to the sorbent material 12. Gas other than carbon dioxide, for example, nitrogen, oxygen, etc., are exhausted to outside of the carbon dioxide recovery device 1 through the fourth valve 24 and the adsorption line 101.

The desorption process is a process of desorbing the carbon dioxide on the sorbent material 12 within the module 11. In the desorption process, the first valve 21, the third valve 23 and the fourth valve 24 of the module 11 are closed, and the second valve 22 is opened. The vacuum pump 62 runs to aspirate inside of the module 11, and reduces the pressure to a vacuum state or brings it close to a vacuum state. Simultaneously, the heat transfer medium serving as a heat source flows with the module 11 to supply thermal energy by way of the heat exchange device 80, whereby the sorbent material 12 of the module 11 is raised in temperature. By temperature-rise control of the sorbent material 12, the sorbent material 12 is also heated to a predetermined temperature (for example, 80° C.) adequate for the desorption process, and the carbon dioxide adsorbed to the sorbent material 12 is desorbed. Next, the second valve 22, the third valve 23 and the fourth valve 24 are closed, the first valve 21 is opened, and the carbon dioxide recovery pump 63 is driven, whereby the carbon dioxide desorbed through the carbon dioxide line 103 is stored in the carbon dioxide tank 66. In the present embodiment, the respective processes are controlled so that, among the sixteen of the modules 11, twelve of them execute the adsorption process, and the remaining four perform the desorption process.

### Power Supply System

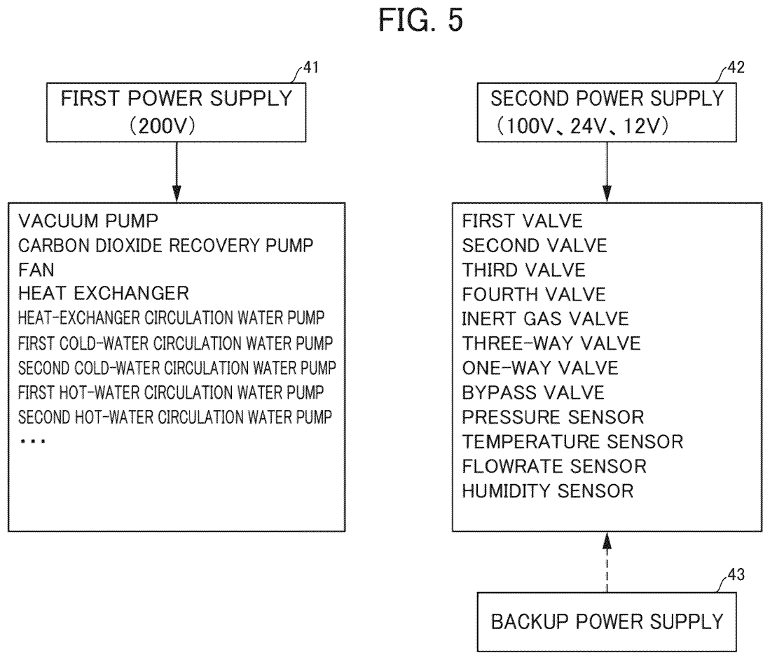

Next, FIG. 5 is referenced to describe the power supply system that supplies electric power to each configuration of the carbon dioxide recovery device 1. FIG. 5 is a schematic diagram showing the power supply system of the carbon dioxide recovery device 1 according to the present embodiment. As shown in FIG. 5, the carbon dioxide recovery device 1 includes a first power supply 41 and a second power supply 42 that supply electric power to various equipment.

The first power supply 41 is a 200-V power supply that supplies electric power to various devices including the configurations for realizing a forced cooling function during emergency. The devices to which electric power is supplied by the first power supply 41, for example, include the fan 61, the vacuum pump 62, the carbon dioxide recovery pump 63, the heat exchanger 81, the heat-exchanger circulation water pump 821, the first cold-water circulation water pump 822, the second cold-water circulation water pump 823, the heat-exchanger circulation water pump 831, the first hot water circulation water pump 832 and the second hot water circulation water pump 833.

Among the devices to which the electric power is supplied by the first power supply 41, the second cold-water circulation water pump 823 is a device that realizes a forced cooling function of performing forced cooling during emergency. It should be noted that the devices performing force cooling during emergency are not limited to the second cold-water circulation water pump 823. In addition to the second cold-water circulation water pump 823, the heat-exchanger circulation water pump 821, first cold-water circulation water pump 822, or the like may be included among the devices performing forced cooling during emergency.

The second power supply 42 is a 100-V, 24-V and 12-V power supply that supplies electric power to various devices including the configurations for realizing the pressure maintenance function during emergency. The devices to which the electric power is supplied by the second power supply 42, for example, include various valves such as the first valve 21, the second valve 22, the third valve 23, the fourth valve 24, the inert gas valve 695, the three-way valves 30, the one-way valve 631 and the bypass valve 32, various measurement instruments and sensors such as the pressure sensor 25, the temperature sensor 27, the temperature sensor 35, the temperature sensor 36 and the flowrate sensor 37, and the like.

Among the devices to which electric power is supplied by the second power supply 42, the first valve 21, the second valve 22, the third valve 23, the fourth valve 24, the pressure sensor 25, the temperature sensor 27, the temperature sensor 35, the temperature sensor 36, the flowrate sensor 37 and the inert gas valve 695 are devices which realize the pressure maintenance function of maintaining the internal pressure of the module 11 during emergency. It should be noted that the devices realizing the pressure maintenance function during emergency are not limited to the first valve 21, the second valve 22, the third valve 23, the fourth valve 24, the pressure sensor 25, the temperature sensor 27, the temperature sensor 35, the temperature sensor 36, the flowrate sensor 37 and the inert gas valve 695. The devices realizing the pressure maintenance function may include other configurations.

Electric power is supplied from the backup power supply 43 during emergency to the devices to which electric power is supplied by the second power supply 42.

The example shown in FIG. 5 is divided into the two groups of: a 200-V power supply corresponding to the first power supply 41 including the devices that realize the forced cooling function; and a 100-V power supply, 24-V power supply and 12-V power supply corresponding to the second power supply 42 including the devices that realize the pressure maintenance function. Even in this example, a carbon dioxide recovery pump, fan, etc., which have no direct relation to the devices realizing the forced cooling function, are also included among devices to which electric power is supplied by the 200-V power supply. At least one among the water pumps in the drawings is included in the devices that realize the forced cooling function. Similarly, three-way valves, one-way valves, radiator fans, etc., which have no direct relation to the devices realizing the pressure maintenance function, are also included among devices to which electric power is supplied by the 100-V power supply, 24-V power supply and 12-V power supply. Some or the entirety of air valves closed and air valves opened are included in the devices realizing the pressure maintenance function. Each device is divided into a first group or a second group; therefore, the capacity of the backup power supply 43 handling the second group can also be reduced as compared to the case of also handling the backup amount of the first group as well as the second group.

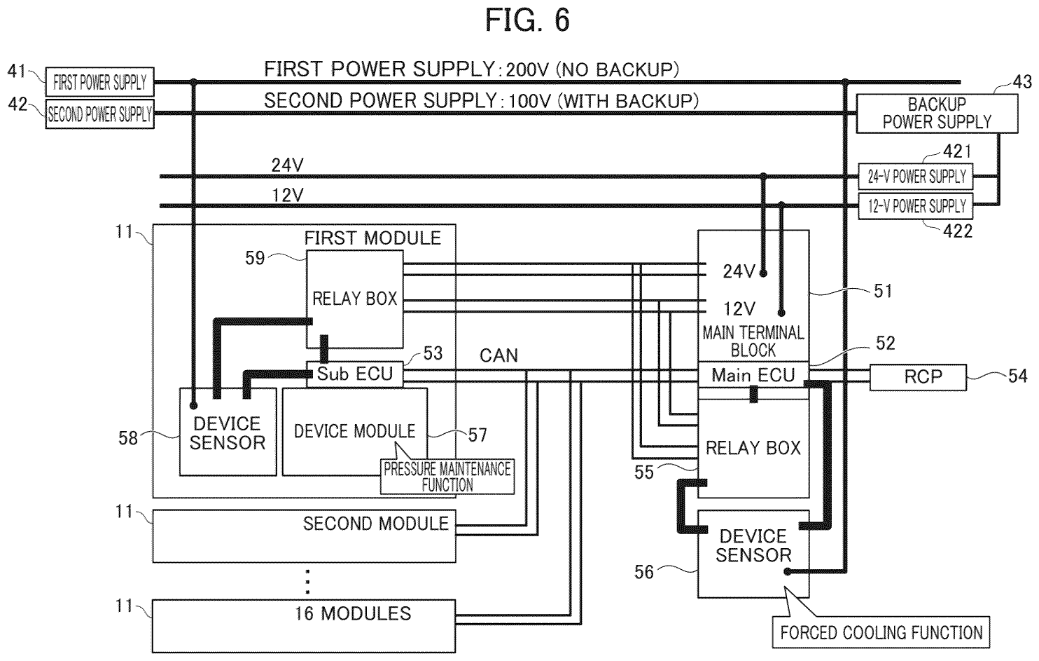

FIG. 6 is a circuit diagram showing the relationship between the power supply system and the module 11 of the carbon dioxide recovery device 1 according to the present embodiment. As shown in FIG. 6, the backup power supply 43 is connected to the electrical system supplying electric power from the second power supply 42

The second power supply 42 that is a 100-V power supply supplies electric power to a 24-V power supply 421 and a 12-V power supply 422. The 24-V power supply 421 transforms the electric power from the second power supply 42 supplies to a main terminal block 51, and the 12-V power supply 422 transforms the electric power from the second power supply 42 and supplies to the main terminal block 51.

The main terminal block 51 is connected to a main ECU (Electronic Control Unit) 52. The main ECU 52 is connected to a sub ECU 53 of each module 11 through a CAN (Controller Area Network), and connected to RCP (Rapid Control Prototyping) 54. In addition, a relay box 55 is connected to the main ECU 52, and a device sensor 56 is connected thereto. Power terminals connected to the power terminals of the main terminal block 51 and connection terminals of signal lines connected to the device sensors 56 are built into the relay box 55. The device sensors 56 are various sensors related to the forced cooling function.

The sub ECU 53 of the module 11 controls a device module 57 that realizes the pressure maintenance function based on a control signal from the main ECU 52. The device module 57 includes a first valve 21, a second valve 22, a third valve 23, a fourth valve 24, etc. The device sensor 58 measuring the pressure, temperature, etc. of the module 11 is connected to the sub ECU 53, and the relay box 59 is connected thereto. The relay box 59 receives the supply of electric power from the 24-V power supply 421 and the 12-V power supply 422 via the main terminal block 51, and is also connected to the device sensor 58. The relationship between the power supply system and the module 11 of the carbon dioxide recovery device 1 has been described above by referencing FIG. 6.

In the present embodiment, inert gas filling control, pressure maintenance control, and forced cooling control are executed according to the loss situation of the power supply, in order to prevent degradation of the sorbent material 12 inside of the module 11 during power outage. Next, each control implemented according to the loss situation of power supply will be described.

### Inert Gas Filling Control

The inert gas filling control is control which is realized by the pressure maintenance function achieved using the electric power of the backup power supply 43. It should be noted that, in the following description, it is assumed that the inside of the module 11 during desorption process execution during normal control becomes negative pressure by the pressure reduction of the vacuum pump 62, and the temperature of the sorbent material 12 becomes a high temperature of a fixed value or higher by way of the heat exchange device 80. In addition, during normal operation, the first valve 21, the tank valve 661, the separator first valve 651 and the separator second valve 652 are controlled to the open state or closed state according to the running situation. It is assumed that the inert gas valve 695 is controlled to the closed state, and the internal pressure of the inert gas tank 69 is maintained at a fixed value or more.

In the inert gas filling control, first, the controller 90 controls all of the tank valve 661, the separator first valve 651 and the separator second valve 652 to the closed state. An upstream side of the carbon dioxide tank 66 in the carbon dioxide line 103 is closed.

Next, the controller 90 executes control on each valve of the module 11 which is the control target and has performed the desorption process. In the present embodiment, the controller 90 maintains the closed state of the fourth valve 24 in the adsorption line 101, and controls the second valve 22 in the vacuum line 102 and the third valve 23 communicating with atmospheric air to the closed state. Furthermore, the inert gas valve 695 in the inert gas supply line 107 is controlled to the opened state. The inert gas tank 69 and the carbon dioxide line 103 are thereby in communication.

Next, the controller 90 controls the first valve 21 in the carbon dioxide line 103 of the module 11 which is the control target to the opened state, thereby opening the carbon dioxide line 103. The inside of the inert gas tank 69 is maintained at a fixed pressure or more; therefore, N₂ as the inert gas flows through the inert gas supply line 107 and the carbon dioxide line 103 to inside of the module 11 which is in a vacuum state or nearly a vacuum state. The inert gas is thereby filled to the inside of the module 11.

### Pressure Maintenance Control

The pressure maintenance control is control realized by the pressure maintenance function achieved using the electric power of the second power supply 42 or the backup power supply 43. The controller 90 controls the first valve 21, the second valve 22, the third valve 23 and the fourth valve 24 of the module 11 which is the control target and has performed the desorption process to the closed state. The internal pressure of the module 11 is thereby maintained.

### Forced Cooling Control

Next, the forced cooling control will be described. The forced cooling control is control realized by the forced cooling function achieved using the electric power of the first power supply 41. In the forced cooling control, the controller 90 controls the three-way valve 30 arranged on an upstream side end of the inlet-side flow path 33 of the module 11 having performed the desorption process to make a connection of the inlet-side flow path 33 with the cold water line 111, and controls the three-way valve 30 arranged at a downstream-side end of the outlet-side flow path 34 to connect the outlet-side flow path 34 with the cold water line 111.

The controller 90 drives the second cold-water circulation water pump 823 to perform pump driving to send the heat transfer medium flowing in the cold water line 111 to a target module 11. In pump driving, in addition to the second cold-water circulation water pump 823, the heat-exchanger circulation water pump 821, the first cold-water circulation water pump 822, etc. may be driven. By way of this pump driving, the heat transfer medium for cooling is sent from the cold water tank 82 to the module 11 through the cold water line 111.

### Operation Control According to Power Supply Status

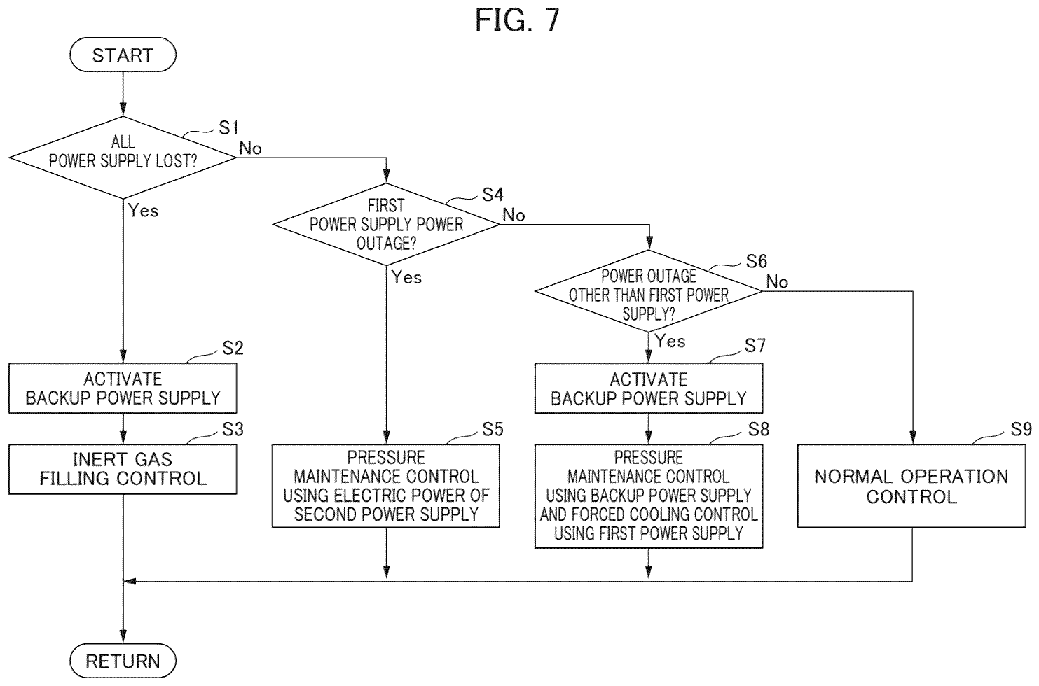

Next, operation control of the carbon dioxide recovery device 1 according to the power supply status will be described by referencing FIG. 7. FIG. 7 is a flowchart showing the flow of processing of operation control according to the power supply status of the carbon dioxide recovery device 1 according to the present embodiment.

In Step S1, the controller 90 determines whether all power supply is lost. In the case of all power supply being lost, the carbon dioxide recovery device 1 will lose the pressure maintenance function and the forced cooling function. In the case of power supply of all of the 200 V from the first power supply 41, and the 100 V, 24 V and 12 V from the second power supply 42 being lost, in order to handle the situation in which the pressure maintenance function and the forced cooling function are lost, the processing advances to Step S2 (Step S1; Yes).

The backup power supply 43 activates in Step S2. By activation of the backup power supply 43, electric power is supplied to various devices connected to the power supply system which had received the supply of electric power from the second power supply 42. The inert gas valve 695, and the first valve 21, second valve 22, third valve 23 and fourth valve 24 of the module 11 realizing the pressure maintenance function are included in various equipment connected to the power supply system of the second power supply 42.

In Step S3, the controller 90 executes inert gas filling control using the pressure maintenance function which was enabled by the activation of the backup power supply 43. By the inert gas filling control, the inert gas is introduced to inside of the module 11 having performed the desorption process. In the example of FIG. 1, the inert gas is filled to inside of the four modules 11 on the upper left. The processing of Step S3, for example, is continued until the internal temperature of the module 11 is determined as being no more than a fixed value, or determined that the inert gas is adequately filled. After the processing of Step S3, the processing returns to Step S1.

Next, a case of determining that power supply of all of the 200 V of the first power supply 41, and the 100 V, 24 V and 12 V of the second power supply 42 is not lost in Step S1 will be described. In the case of being determined that all power supply is not lost, the processing advances to Step S4 (Step S1; No).

In Step S4, the controller 90 determines whether the first power supply 41 is stopped. In the case of the first power supply 41 being stopped, the forced cooling function will be lost. In the case of the first power supply 41 being lost, the processing advances to Step S5.

In Step S5, the controller 90 performs pressure maintenance control on the module 11 having performed the desorption process, using the electric power of the second power supply 42 which is not stopped. By this pressure maintenance control, the internal pressure of the module 11 that is the target is maintained, and this module 11 is allowed to cool naturally. The natural cooling, for example, is continued until the internal temperature of the module 11 becomes a fixed value or less, referencing the measurement information of the temperature sensor 27. Since the second power supply 42 is operating, it is possible to maintain the pressure maintenance state even if it takes time in the natural cooling, contrary to a case of supplying electric power to each valve by the backup power supply 43. After the processing of Step S5, the processing returns to Step S1.

Next, a case of the first power supply 41 not being stopped in Step S4 will be described. In the case of the first power supply 41 not being stopped, the processing advances to Step S6. In Step S6, the controller 90 determines that power supply (100 V, 24 V and 12 V of second power supply) other than the first power supply 41 is not stopped.

The controller 90, in the case of power supply other than the first power supply 41 being stopped, advances the processing to the processing of Step S7 in which the backup power supply 43 activates. In Step S7, after activating the backup power supply 43, the controller 90 advances the processing to Step S8.

In Step S8, the controller 90 performs pressure maintenance control on the module 11 which is the target, using the electric power supplied by the backup power supply 43, and performs forced cooling control using the electric power of the first power supply 41 which has not stopped. This processing, for example, is performed until the internal temperature becomes a fixed value or less, referencing the measurement information of the temperature sensor 27. The cooling target of the forced cooling control is the four modules 11 on the upper left in FIG. 3. After the processing of Step S8, the processing returns to Step S1.

In the case of power supply other than the first power supply 41 not being stopped (Step S6; No), since all of the power supplies are performing electric power supply without trouble, the controller 90 advances the processing to Step S9 for performing normal operation. In normal operation, the control for performing recovery of carbon dioxide is executed as described above. After performing the processing of Step S9, the processing returns to Step S1.

As described above, the carbon dioxide recovery device 1 according to the present embodiment includes: the module 11 that includes a sorbent material 12 inside thereof, and executes an adsorption process of aspirating a gas containing carbon dioxide and adsorbing the carbon dioxide to the sorbent material 12; and a desorption process of desorbing the carbon dioxide from the sorbent material 12 by heating in a state where a periphery of the sorbent material 12 is reduced pressure; the heat exchange device 80 that performs cooling of the sorbent material 12 by carrying out heat exchange with the module 11; a valve (first valve 21, second valve 22, third valve 23 and fourth valve 24) for controlling influx and outflux of a gas relative to the inside of the module 11; the first power supply 41 that supplies electric power for performing cooling of the sorbent material 12 by way of at least the heat exchange device 80; the second power supply 42 that supplies electric power to at least the valve; and the backup power supply 43 that supplies electric power to the valve during power outage of the second power supply 42, in which during power outage of the first power supply 41, the carbon dioxide recovery device executes, on the module 11 which was reduced in pressure and reached a high temperature in the desorption process, pressure maintenance control to maintain internal pressure of the module 11 by controlling the valve using electric power of the second power supply 42 to prevent influx of atmospheric air, and during power outage of the second power supply 42, controls the valve using electric power of the backup power supply 43 to prevent influx of atmospheric air to the module which was reduced in pressure and reached a high temperature in the desorption process, and to maintain the internal pressure of the module 11.

Since the internal pressure of the module 11 is thereby maintained even when power outage occurs, it is possible to prevent the influx of atmospheric air to inside of the module 11, and thus it is possible to avoid the occurrence of a situation where the sorbent material 12 comes into contact with atmospheric air while a high temperature state, and oxidizing, and degrading. Since the sorbent material 12 is also naturally cooled, even if the supply of electric power by the backup power supply 43 I stopped, the sorbent material 12 will not degrade with the elapse of time. In addition, it is possible to reduce the capacity required from the backup power supply 43, since the backup power supply 43 only needs to handle the capacity of the second power supply 42.

In addition, in the present embodiment, during power outage of the second power supply 42, the valves are controlled using the electric power of the backup power supply 43 to prevent the influx of atmospheric air and maintain the internal pressure of the module 11, and the heat exchange device 80 is controlled to perform forced cooling of the module 11. Since cooling of the sorbent material 12 is rapidly carried out by forced cooling, it is thereby possible to more reliably prevent degradation of the sorbent material 12. In addition, the time for which maintaining the internal pressure of the module 11 can also be shortened by the electric power of the backup power supply 43.

In addition, in the present embodiment, during power outage of both the first power supply 41 and the second power supply 42, the valves are controlled using the backup power supply 43 to prevent the influx of atmospheric air, and maintain the internal pressure of the module 11. It is thereby possible to prevent degradation of the sorbent material 12 by natural cooling while maintaining the internal pressure of the module 11 using the electric power from the backup power supply 43.

In addition, the present embodiment further includes the inert gas tank 69 which can supply inert gas to the inside of the module 11, and thus, during power outage of both the first power supply 41 and the second power supply 42, the influx of atmospheric air to inside of the module 11 is prevented, and inert gas from the inert gas tank 69 is supplied to the inside of the module 11. It is thereby possible to realize shortening of the cooling time by the introduction of inert gas. In addition, since the periphery of the sorbent material 12 is covered with inert gas, it is possible to more reliably avoid the occurrence of a situation where the sorbent material 12 comes into contact with atmospheric air while in a high temperature state, and then oxidizing and degrading.

Although embodiments of the present invention have been described above, it is not to be limited to the aforementioned embodiments and modified examples thereof. In addition, the effects described in the above embodiments are merely exemplifying the preferred effects, and the effects thereof are not limited to those described in the above embodiments.

### EXPLANATION OF REFERENCE NUMERALS

1 carbon dioxide recovery device
11 module
12 sorbent material
21 first valve
22 second valve
23 third valve
24 fourth valve
41 first power supply
42 second power supply
43 backup power supply
69 inert gas tank
80 heat exchange device

What is claimed is:

1. A carbon dioxide recovery device comprising:
a module that includes a sorbent material inside thereof, and executes an adsorption process of aspirating a gas containing carbon dioxide and adsorbing the carbon dioxide to the sorbent material; and a desorption process of desorbing the carbon dioxide from the sorbent material by heating in a state where a periphery of the sorbent material is reduced pressure;
a heat exchanger that performs cooling of the sorbent material by carrying out heat exchange with the module;
a valve for controlling influx and outflux of a gas relative to the inside of the module;
a first power supply that supplies electric power for performing cooling of the sorbent material by way of at least the heat exchanger;
a second power supply that supplies electric power to at least the valve; and
a backup power supply that supplies electric power to the valve during power outage of the second power supply,
wherein, during power outage of the first power supply, the carbon dioxide recovery device executes, on the module which was reduced in pressure and reached a high temperature in the desorption process, pressure maintenance control to maintain internal pressure of the module by controlling the valve using electric power of the second power supply to prevent influx of atmospheric air, and
during power outage of the second power supply, controls the valve using electric power of the backup power supply to prevent influx of atmospheric air to the module which was reduced in pressure and reached a high temperature in the desorption process, and to maintain the internal pressure of the module.

2. The carbon dioxide recovery device according to claim 1, wherein, during power outage of the second power supply, the carbon dioxide recovery device controls the valve using electric power of the backup power supply to prevent influx of atmospheric air and maintain internal pressure of the module, and controls the heat exchanger using electric power of the first power supply to perform forced cooling of the module.

3. The carbon dioxide recovery device according to claim 1, wherein, during power outage of both the first power supply and the second power supply, the carbon dioxide recovery device controls the valve using the backup power supply to prevent influx of atmospheric air and maintain internal pressure of the module.

4. The carbon dioxide recovery device according to claim 3, further comprising an inert gas tank configured to supply an inert gas to the inside of the module,
wherein, during power outage of both the first power supply and the second power supply, the carbon dioxide recovery device prevents influx of atmospheric air to inside of the module and supplies the inert gas from the inert gas tank to the inside of the module.
